(19) United States
(12) Patent Application Publication
(10) Pub. No.: US 2008/0034798 A1
(43) Pub. Date: Feb. 14, 2008

(54) Reduced size bowl for display glass melting and delivery

(76) Inventors: Richard Bergman, Horseheads, NY (US); Raymond Eugene Fraley, Waverly, NY (US); May Yammei Xun, Elmira, NY (US)

Correspondence Address: CORNING INCORPORATED, SP-TI-3-1, CORNING, NY, 14831, US

(21) Appl. No.: 11/500,592

(22) Filed: Aug. 8, 2006

(51) Int. Cl. C03B 13/00; C03B 5/26

(52) U.S. Cl. 65/90; 65/324

(57) ABSTRACT

The present invention provides an improved apparatus for forming sheet glass, wherein the apparatus includes a reservoir from which to provide molten glass, an inlet plate in fluid communication with the reservoir to receive the molten glass from the reservoir in a flow direction, the inlet pipe having a cross-sectional area orthogonal to the fluid direction, and a trough in fluid communication with the inlet pipe to receive the molten glass and that is operably coupled to a wedge-shaped sheet forming structure to form the molten glass into a glass sheet. The improvement comprises a bowl that provides fluid communication between the inlet pipe and the trough, the bowl having a cross-sectional area orthogonal to a fluid direction at the molten through the bowl that is equal to or less than the cross-sectional area of the inlet pipe, thereby preventing stagnation of the molten glass within the bowl. Another embodiment of the present invention is a method that utilizes the inventive apparatus to form glass sheet.

### BACKGROUND OF THE INVENTION

1. Field of the Invention

The present invention relates to the manufacture of glass sheet, and more particularly, to an improved process for the manufacture of glass sheet that eliminates stagnation of molten glass within an overflow-type process.

2. Description of Related Art

Glass used for semiconductor powered display applications, and particularly for TFT-LCD display devices and OLED display devices that are widely used for displays within PDAs, computer displays and the like, must provide a high surface quality to allow the successful application of semiconductor-type material. Sheet glass as manufactured utilizing the apparatus disclosed in U.S. Pat. No. 3,338,696, entitled SHEET FORMING APPARATUS, makes the highest quality glass as formed that does not require post-formation processing. This patent specifically discloses a manufacturing process typically referred to as “the overflow process,” that is particularly advantageous as glass manufactured utilizing this process does not require the grinding and/or polishing as is required with other processes, and further provides a higher quality surface finish.

One of the problems associated with the overflow process is the formation of stagnant glass within at least one of the associated steps of the manufacturing process. As is known, stagnant glass formed during the process results in streak or cord defects in the ultimately formed glass sheet, thereby making the sheet unacceptable for the uses as noted above. This streak or cord may be caused from a change in the composition of the molten glass as the molten glass sits or is stagnant within some station or position within the overall process, and/or from a change in composition resulting from the mixture of a previous run molten glass formulation with that composition currently being processed. Specifically, the prior art apparatus utilized to accomplish the overflow process recovers from transient conditions relatively slowly. The cause of this slow recovery is in part caused by quiescent or stagnant zones of glass flow within the associated apparatus. During unintended process transient, these stagnant zones slowly bleed glass of a previous material composition into the main process stream of the current batch of glass being processed, thereby effecting the overall composition of the glass and causing defects therein. These defects eventually subside as the glass is processed, however, a significant amount of processed glass may be unsuitable for use, thereby increasing overall scrap rates. Moreover, previous manufacturing systems have incorporated relatively large bowls therein, so as to provide sufficient thermal mixing of the molten glass, but which contributes to the formation of stagnant glass.

Therefore, an apparatus and related method is needed that reduces the formation of stagnant glass and resultant glass defects in the overall process of glass sheet manufacture.

### SUMMARY OF THE INVENTION

In a preferred embodiment of the present invention, an improved apparatus for forming sheet glass is provided, wherein the apparatus includes a reservoir from which to provide molten glass, an inlet pipe in fluid communication with the reservoir to receive the molten glass from the reservoir in a flow direction, the inlet pipe having a cross-sectional area orthogonal to the flow direction, and a trough in fluid communication with the inlet pipe to receive the molten glass and that is operably coupled to a wedge-shaped forming structure to form the molten glass into a glass sheet. The improvement comprises a bowl that provides fluid communication between the inlet pipe and the trough, wherein the bowl has a cross-sectional area orthogonal to a flow direction of the molten glass through the bowl that is equal to or less than the cross-sectional area of the inlet pipe.

In another preferred embodiment, the bowl includes a cross-sectional configuration in the flow direction that is arcuately shaped and downwardly sloped, while in another preferred embodiment the bowl includes a first portion that is substantially circularly shaped, and a second portion that is substantially conically shaped.

In yet another preferred embodiment, a method for forming sheet glass is provided that comprises providing a reservoir that stores molten glass therein, and providing an inlet tube that receives the molten glass from the reservoir, wherein the inlet pipe has a cross-sectional area orthogonal to a direction of flow of the molten glass in the glass pipe. The method also comprises providing a bowl that receives the molten glass from the inlet pipe, wherein the bowl has a cross-sectional area orthogonal to a direction of the flow of the molten glass through the bowl that is equal to or less than the cross-sectional area of the inlet pipe, thereby eliminating stagnation of the molten glass within the bowl. The method further comprises providing a trough that receives the molten glass from the bowl, and forming a glass sheet by flowing the molten glass from the trough and over a wedge-shaped sheet forming structure.

The present invention provides a method and related apparatus that reduces the formation of stagnant glass and resultant glass defects in the overall process of glass sheet manufacture. The present invention further results in reduced manufacturing costs by decreasing related scrap rates, may be economically implemented within existing manufacturing systems, and is particularly well adapted for the proposed use.

These and other advantages of the invention will be further understood and appreciated by those skilled in the art by reference to the following written specification, claims and appended drawings.

### BRIEF DESCRIPTION OF THE DRAWINGS

FIG. 1 is a schematic view of a manufacturing system utilized to produce glass sheet and incorporating the present invention;

FIG. 2 is a perspective view of an inlet pipe bowl, downcomer pipe and forming apparatus inlet pipe of the manufacturing system;

FIG. 3 is a side view of the inlet pipe, bowl, downcomer pipe and forming apparatus inlet pipe;

FIG. 4 is a cross-sectional end view of the inlet pipe taken along the line IV-IV, FIG. 2;

FIG. 5 is an enlarged perspective view of the inlet pipe and the bowl;

FIG. 6 is a cross-sectional top view of the bowl taken along the line VI-VI, FIG. 5; and

FIG. 7 is a perspective view of an alternatively-configured bowl.

### DETAILED DESCRIPTION OF THE PREFERRED EMBODIMENTS

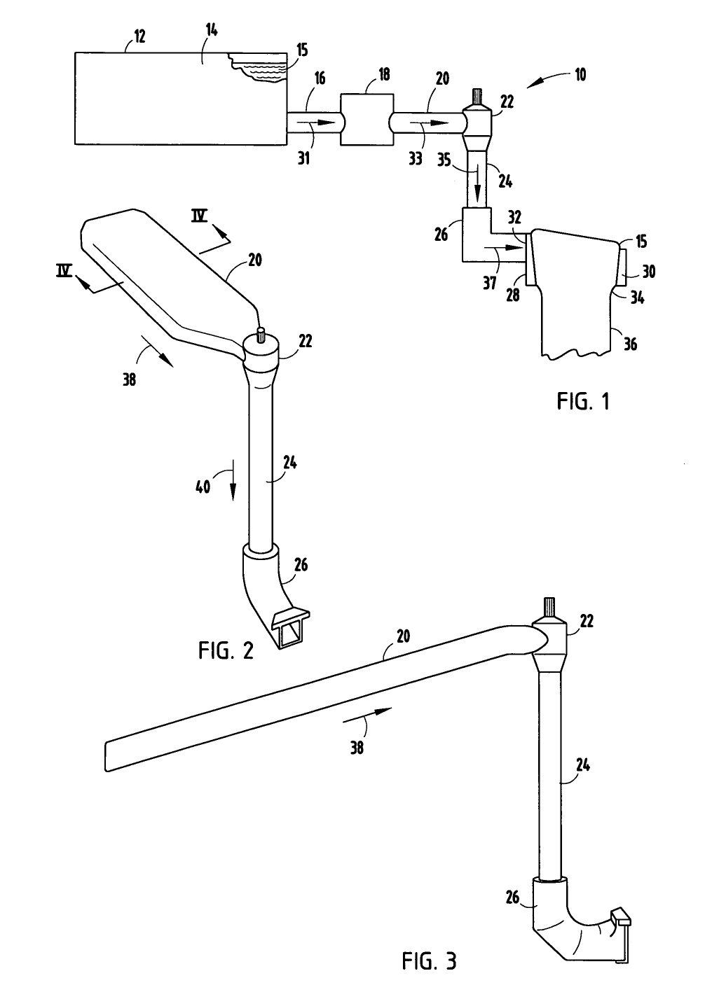

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 10 (FIG. 1) generally designates a glass sheet manufacturing system incorporating the present invention. In the illustrated example, the glass sheet manufacturing system 10 includes a glass melting furnace 12 having a reservoir 14 for housing molten glass 15 therein. A forehearth 16 provides fluid communication between the reservoir 14 and a stirring device 18. An inlet pipe 20 provides fluid communication for the flow of the molten glass 15 from the stirring device 18 to a bowl 22. A downcomer pipe 24 extends downwardly from the bowl 22 and provides fluid communication between the bowl 22 and a forming apparatus inlet pipe 26, that is in turn in fluid communication with a trough 28 having a wedge-shaped sheet forming structure 30.

In operation, the molten glass 15 stored within the reservoir 14 flows through the forehearth 16 in a direction 31 at a substantially uniform temperature and chemical composition to the stirring device 18 where the molten glass is homogenized. The molten glass 15 is then conducted in a direction 33 through the inlet pipe 20 to the bowl 22, downwardly in a direction 35 through a downcomer pipe 24, through the forming apparatus inlet pipe 26 in a direction 37, and to the trough 28 via a trough inlet 32. In a manner known in the art, the molten glass 15 is then flowed from the trough 28 over the sheet forming structure or wedge 30 to form a sheet of molten glass 34 that solidifies into a solid glass sheet 36.

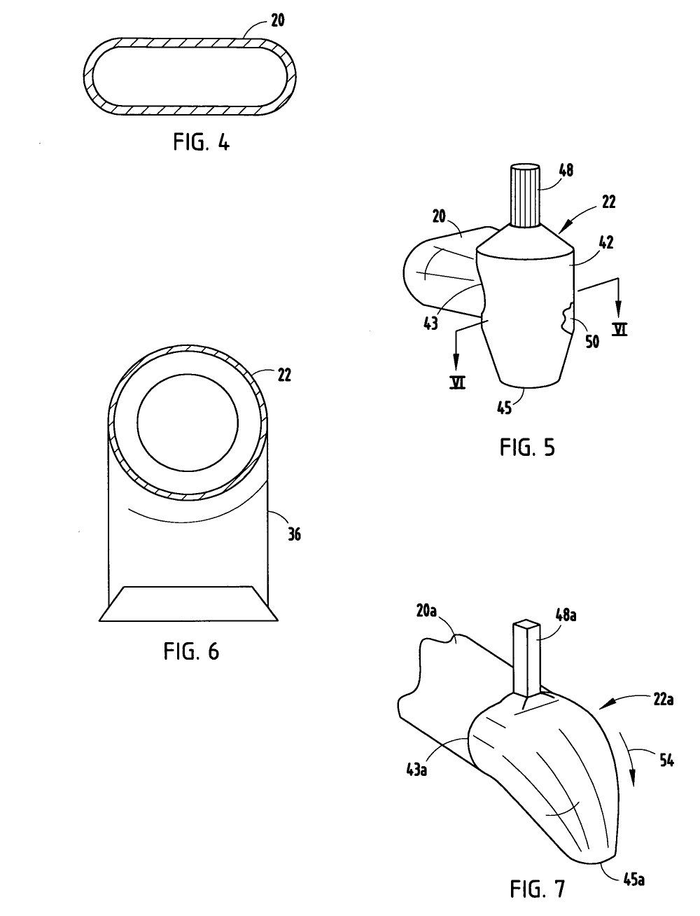

The molten glass 15 is delivered from the stirring device 18 in a homogenized state and must remain so as it is passed through the inlet pipe 20, the bowl 22, the downcomer pipe 24, the forming apparatus inlet pipe 26, and the trough 28 until being formed into the solid glass sheet 36. The normal purpose of the bowl 22 (FIGS. 2 and 3) is to alter the flow direction of the molten glass 15 from a given feed direction 38 to the vertical direction 35. In order to prevent stagnation of the molten glass 15 within the bowl 22, the bowl 22 of the present inventive apparatus is provided so as to have a reduced cross-sectional area. Specifically, as best illustrated in FIG. 4, the inlet pipe 20 is provided an oval-shaped cross-sectional configuration having a given cross-sectional area defined perpendicular to the feed direction 38 at any given point along the length thereof. Similarly, the bowl 22 is also provided with a given cross-sectional area perpendicular to the directional flow of the molten glass 15 therethrough. In the illustrated example, one preferred embodiment of the bowl 22 (FIG. 5) includes a circularly-shaped upper portion 42 having an inlet 43 coupled to the inlet pipe 20, and a conically-shaped bottom portion 44 extending downwardly from the upper portion 42 and having an outlet 45 coupled to the downcomer pipe 24. The overall volume and cross-sectional area of the bowl 22 is sized so as to force a nearly continuous flow of the molten glass 15 through the bowl 22 and prevent stagnation of the molten glass 15 therein.

In the illustrated example, the bowl 22 comprises a thin metal, preferably platinum or a platinum alloy. As best illustrated in FIG. 5, a vent tube or standpipe 48 is attached to a top of the bowl 22 and provides fluid communication with an interior 50 of the bowl 22 and ambient atmosphere, thereby allowing pressure balancing between the interior 50 of the bowl 22 and the surrounding environment to prevent a collapse of the bowl 22 due to internal suction. It is noted that the bowl 22 is heated with either windings or by direct firing of the metal liner.

The reference numeral 22a (FIG. 7) represents another preferred embodiment of the bowl. Since the overall manufacturing system 10 is relatively the same regardless of whether the bowl 22 or the bowl 22a are utilized therein, similar parts appearing in FIG. 5 and FIG. 7, respectively are represented by the same reference numeral except for the suffix “a” in the numeral of the latter. In the illustrated example, the bowl 22a is provided with a downwardly-sloping arcuate shape relative to the direction of the molten glass 15 therethrough. Further, the bowl 22a has a cross-sectional area determined perpendicular to the direction of flow 54 of the molten glass 15 therethrough that is decreasing along a majority of the overall length of the bowl 22a. The slope and decreasing geometry of the bowl 22a promotes constant flow of the molten glass 15 through the bowl 22a and prevents stagnation of the same.

The present invention provides a method and related apparatus that reduces the formation of stagnant glass and resultant glass defects in the overall process of glass sheet manufacture. The present invention further results in reduced manufacturing costs by decreasing related scrap rates, may be economically implemented within existing manufacturing systems, and is particularly well adapted for the proposed use.

It will become apparent to those skilled in the art that various modifications to the preferred embodiment of the invention as described herein can be made without departing from the spirit or scope of the invention as defined in the appended claims. Thus, it is intended that the present invention covers the modifications and variations of this invention provided they come within the scope of the appended claims and the equivalents thereto.

The invention claimed is:

1. An improved apparatus for forming sheet glass, wherein the apparatus includes a reservoir from which to provide molten glass, an inlet pipe in fluid communication with the reservoir to receive the molten glass from the reservoir in a flow direction, the inlet pipe having a cross-sectional area orthogonal to the flow direction, and a trough in fluid communication with the inlet pipe to receive the molten glass and that is operably coupled to a wedge-shaped sheet forming structure to form the molten glass into a glass sheet, the improvement comprising:
a bowl that provides fluid communication between the inlet pipe and the trough, the bowl having a cross-sectional area orthogonal to a flow direction of the molten glass through the bowl that is equal to or less than the cross-sectional area of the inlet pipe, thereby eliminating stagnation of the molten glass within the bowl.

2. The apparatus of claim 1, wherein the bowl includes an inlet, an outlet and a length defined between the inlet and the outlet in the flow direction, and wherein the cross-sectional area of the of the bowl decreases in the flow direction along a majority of the length of the bowl.

3. The apparatus of claim 1, wherein a cross-sectional configuration of the bowl in the flow direction is arcuately shaped.

4. The apparatus of claim 3, wherein the bowl is downwardly sloped.

5. The apparatus of claim 1, wherein the bowl includes a first portion that is substantially circularly-shaped, and a second portion that is substantially conically-shaped.

6. The apparatus of claim 1, wherein the bowl includes a vent tube in fluid communication with an interior of the bowl and ambient atmosphere.

7. The apparatus of claim 1, wherein the bowl is located above at least a portion of the inlet pipe.

8. The apparatus of claim 2, wherein the bowl is coupled with the inlet pipe such that the inlet pipe extends upwardly to the bowl.

9. A method for forming sheet glass, comprising:
providing a reservoir that stores molten glass therein;
providing an inlet pipe that receives the molten glass from the reservoir, the inlet pipe having a cross-sectional area orthogonal to a direction of flow of the molten glass in the inlet pipe;
providing a bowl that receives the molten glass from the inlet pipe, the bowl having a cross-sectional area orthogonal to a direction of flow of the molten glass in the bowl that is equal to or less than the cross-sectional area of the inlet pipe, thereby eliminating stagnation of the molten glass within the bowl;
providing a trough that receives the molten glass from the bowl; and
forming a glass sheet by flowing the molten glass from the trough over a wedge-shaped sheet forming structure.

10. The method of claim 9, wherein the step of providing the bowl includes providing the bowl with an inlet, an outlet and a length defined between the inlet and the outlet, and such that the cross-sectional area of the bowl decreases in the direction of the flow of the molten glass along a majority of the length of the bowl.

11. The method of claim 9, wherein the step of providing the bowl includes providing the bowl with a cross-sectional configuration that is arcuately shaped in the direction of the flow of the molten glass.

12. The method of claim 11, wherein the step of providing the bowl includes providing the bowl such that the bowl is downwardly sloped in the direction of the flow of the molten glass.

13. The method of claim 9, wherein the step of providing the bowl includes providing the bowl with a first portion that is substantially circularly shaped, and a second portion that is substantially conically shaped.

14. The method of claim 9, wherein the step of providing the bowl includes providing the bowl with a vent tube in fluid communication with an interior of the bowl and ambient atmosphere.

15. The method of claim 9, wherein the step of providing the inlet pipe includes providing the inlet pipe such that the at least a portion of the inlet pipe is located below the bowl.

16. The method of claim 15, wherein the step of providing the inlet pipe includes providing the inlet pipe such that the inlet pipe extends upwardly to the bowl.
